(19) United States
(12) Patent Application Publication
(10) Pub. No.: US 2007/0298647 A1
(43) Pub. Date: Dec. 27, 2007

(54) REUSABLE PINATA

(76) Inventors: Mikal Shane Lee, Murphy, TX (US); Darrell K. Hargrove, Rockwall, TX (US)

Correspondence Address: MICHAEL A. O'NEIL, P.C., 5949 SHERRY LANE, SUITE 820, DALLAS, TX, 75225, US

(21) Appl. No.: 11/767,557

(22) Filed: Jun. 25, 2007

Related U.S. Application Data
(60) Provisional application No. 60/805,828, filed on Jun. 26, 2006.

(51) Int. Cl. H01R 13/627

(52) U.S. Cl. 439/354

(57) ABSTRACT

A reusable piñata comprises a non-frangible housing having a treat discharge port formed therein and a target mounted thereon. A mechanism mounted within the housing discharges treats through the treat discharge port when the target is engaged by a thrown object.

### CROSS-REFERENCE TO RELATED APPLICATION

Applicant claims priority based on provisional patent application Ser. No. 60/805,828 filed Jun. 26, 2006, the entire content of which is incorporated herein by reference.

### TECHNICAL FIELD

This invention relates generally to children's party toys, and more particularly to piñatas.

### BACKGROUND AND SUMMARY OF THE INVENTION

Webster's Third New International Dictionary defines a piñata as: a decorated pottery jar filled with candies, fruits, toys, or other gifts and usually suspended from the ceiling that blindfolded children try to break with a stick as a traditional part of Mexican Christmas festivities. Modern piñatas are most often manufactured from either paper or a fragile plastic material in lieu of pottery. Particularly when intended for use by older children, piñatas are often suspended from a cord which extends through a pulley thereby facilitating movement of the piñata as the children try to break the piñata to gain access to the treats contained therein.

Regardless of the materials utilized in the construction thereof, virtually all prior art piñatas nave been formed from one or more frangible materials. Thus, traditional piñatas are designed to be destroyed during use.

The present invention departs from traditional piñata designs by providing a reusable piñata. More specifically, the piñata of the present invention comprises a non-frangible housing which receives a quantity of wrapped candies, wrapped fruits, toys, and other treats for children. A trigger is mounted on the housing for engagement by a thrown object, preferably a beanbag or the like. When the trigger is engaged, by a thrown object a mechanism within the housing discharges a quantity of treats for recovery by children playing with the piñata. Thereafter the treat discharging mechanism is reset, the housing is refilled with treats, and the piñata is ready for further use.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of the piñata of the present invention illustrating the use thereof;

FIG. 2 is a sectional view illustrating the trigger mechanism of the piñata of FIG. 1;

FIG. 3A is a sectional view showing the treat discharging mechanism of the piñata of FIG. 1 in its cocked configuration;

FIG. 3B is a sectional view showing the treat discharging mechanism of the piñata of FIG. 1 in its discharged configuration;

FIG. 4 is a perspective view of a piñata comprising another embodiment of the present invention;

FIG. 5 is a perspective view of a piñata comprising an alternate physical configuration of the piñata shown in FIGS. 1 through 3B;

FIG. 6 is a perspective view of a piñata comprising another alternate physical configuration of the piñata shown in FIGS. 1 through 3B;

FIG. 7 is a perspective view of a piñata comprising yet another alternate physical configuration of the piñata shown in FIGS. 1 through 3B;

FIG. 8 is a perspective view of a piñata comprising still another alternate physical configuration of the piñata shown in FIGS. 1 through 3B;

FIG. 9 is a perspective view of a piñata comprising another alternate physical configuration of the piñata shown in FIGS. 1 through 3B;

FIG. 10 1s a perspective view of a piñata comprising yet another alternate physical configuration of the piñata shown in FIGS. 1 through 3B;

FIG. 11 is a perspective view of a piñata comprising still another alternate physical configuration of the piñata shown in FIGS. 1 through 3B;

FIG. 12 is a perspective view of a piñata comprising yet another embodiment of the present invention;

FIG. 13 is a perspective view of a piñata comprising still another embodiment of the present invention;

FIG. 14 is a section view of the treat discharging mechanism of the piñata of FIG. 13;

FIG. 15 is a perspective view of a piñata comprising an alternate physical configuration of the piñata shown in FIG. 14; and

FIG. 16 is a perspective view of a piñata comprising another alternate physical configuration of the piñata shown in FIG. 14.

### DETAILED DESCRIPTION

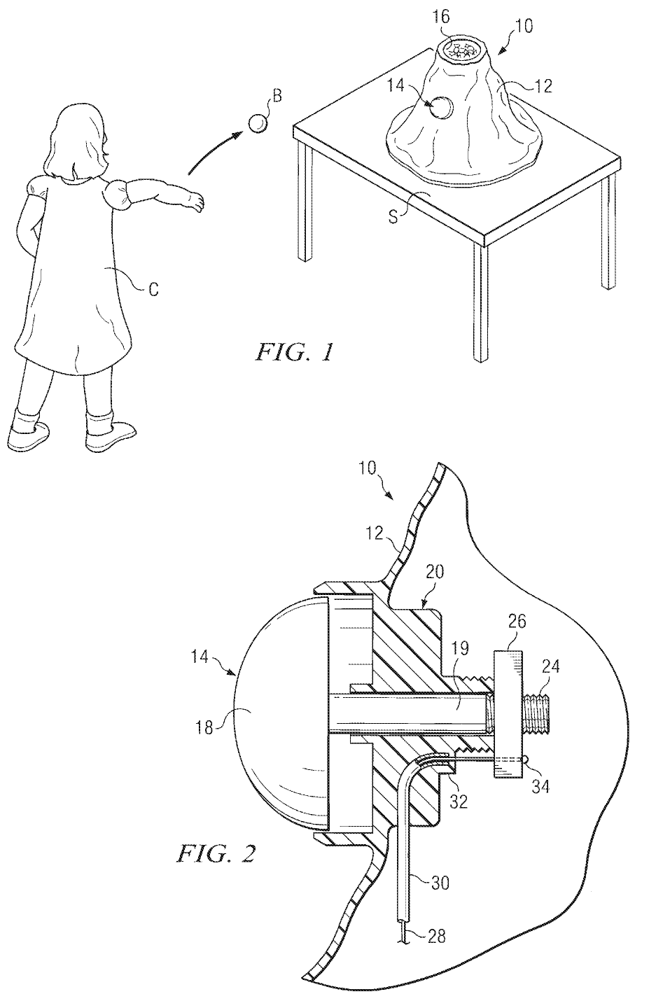

Referring now to the drawings, and particularly to FIG. 1 thereof, there is shown a reusable piñata 10 incorporating the present invention. The reusable piñata 10 comprises an embodiment of the invention adapted for support on a surface S comprising a table or other convenient supporting device. As will be appreciated by those skilled in the art, the reusable piñata of the present invention can also be configured for overhead support by means of a rope, wire, etc. in the manner of a conventional piñata.

The reusable piñata 10 comprises a body 12 configured in the shape of a volcano. As will be appreciated by those skilled in the art, the reusable piñata of the present invention may be incorporated in a wide variety of body configurations depending upon the requirements of particular applications of the invention. A target 14 is mounted on and supported by the body 12 of the reusable piñata 10. The upper portion of the body 12 comprises a treat discharge port 16.

Referring to FIG. 2, the target 14 of the reusable piñata 10 is illustrated in greater detail. The target 14 comprises a hemisphere 18 formed from plastic, rubber, or other suitable materials. The hemisphere 18 is supported on a rod 19 which is slidably supported in a guide 20. The guide 20 can be formed integrally with the body 12 or secured thereto by conventional means.

The end of the rod 19 opposite the hemisphere 18 is threaded as illustrated at 24 and receives a nut 26 which engages the guide 20 to limit outward movement of the hemisphere 18 under the action of the spring 22.

A trip wire 28 extends through a guide tube 30. One end of the guide tube 30 is secured in a fixture 32 comprising part of the guide 20. The corresponding end of the trip wire 28 is secured to the nut 26 as indicated at 34. It will therefore be understood that when the hemisphere 18 of the target 14 is moved inwardly the trio wire 28 is moved longitudinally relative to the guide 30.

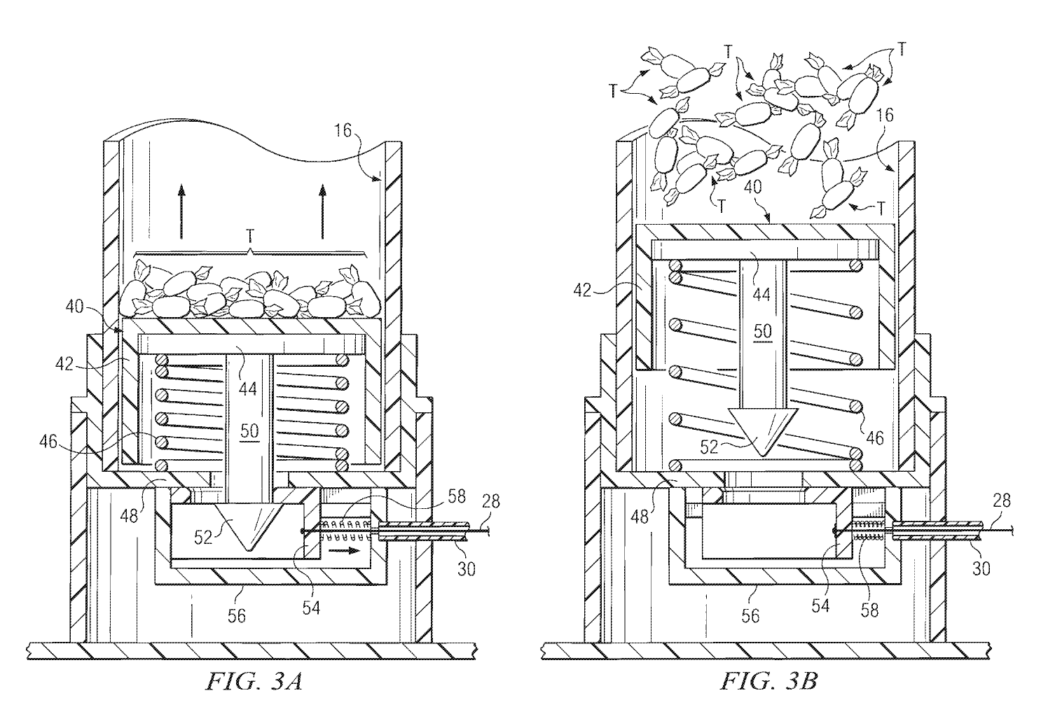

Referring to FIGS. 3A and 31B, the reusable piñata 10 further comprises a treat discharge apparatus 40. The treat discharge apparatus 40 in part comprises the treat discharge port 16 and includes an outer treat discharging piston 42 having an exterior dimension closely matched to the interior dimension of the treat discharge port 16 and an interior piston 44 which is received within the treat discharging piston 42. One or more treats T comprising wrapped candy, wrapped fruits, toys, etc. are initially received on the treat discharging piston 42.

A spring 46 is mounted between the interior piston 44 and an interior surface 48. A rod 50 extends from the interior piston 44 to a first latching member 52.

A second latching member 54 is slidably supported within a housing 56 extending beneath the interior surface 48. A compression spring 58 normally positions the second latching members 54 as illustrated in FIG. 3A. When so positioned the second latching member 54 engages the first latching member 52 to retain the interior piston 44 and the treat discharging piston 42 in the positions illustrated in FIG. 3A.

The guide 30 extends from the target 14 and is secured at the opposite end thereof to the housing 56. The trip wire 28 extends through the guide 30 and is secured at the end thereof remote from the target 14 to the second latching member 54.

As will therefore be understood, when the hemisphere 18 of the target 14 is moved inwardly the trip wire 28 is moved rightwardly (FIG. 3B) thereby disengaging the second latching member 54 from the first latching member 52. When the second latching member 54 becomes disengaged from the first latching merger 52 the interior piston 44 and the treat discharging piston 42 are moved rightwardly upwardly under the action of the spring 46 thereby discharging treats T from the interior of the treat discharge port 16 and outwardly for recovery by children playing with the reusable piñata 10.

Referring again to FIG. 1, a child C is shown throwing a soft projectile B toward the target 14 of the reusable piñata 10. The soft projectile B may comprise a conventional beanbag, a small bag formed from a soft cloth or plastic material and filled with plastic beads, or the like, which is inherently much less dangerous; even when thrown; as compared with the sticks which are typically utilized by children in attempting to extract treats from conventional piñatas.

Use of the reusable piñata 10 begins with movement of the treat discharging piston 42 and the interior piston 44 downwardly relative to the body 12 against the action of spring 46 until the first latching member 52 is engaged with the second latching member 54 in the manner illustrated in FIG. 3A. Selected treats T are then introduced into the treat discharge port 16 and come to rest on the treat discharging piston 42. Thereafter children are encouraged to take turns throwing the projectile B at the target 14. The children may or may not be blindfolded during this activity. Whenever the projectile B strikes the target 14 the first latching member 52 is disengaged from the latching member 54 whereupon the spring 46 causes the treat discharging piston 42 to move upwardly under the action of the spring 46 thereby discharging the treats T from the interior of the treat discharge port 16.

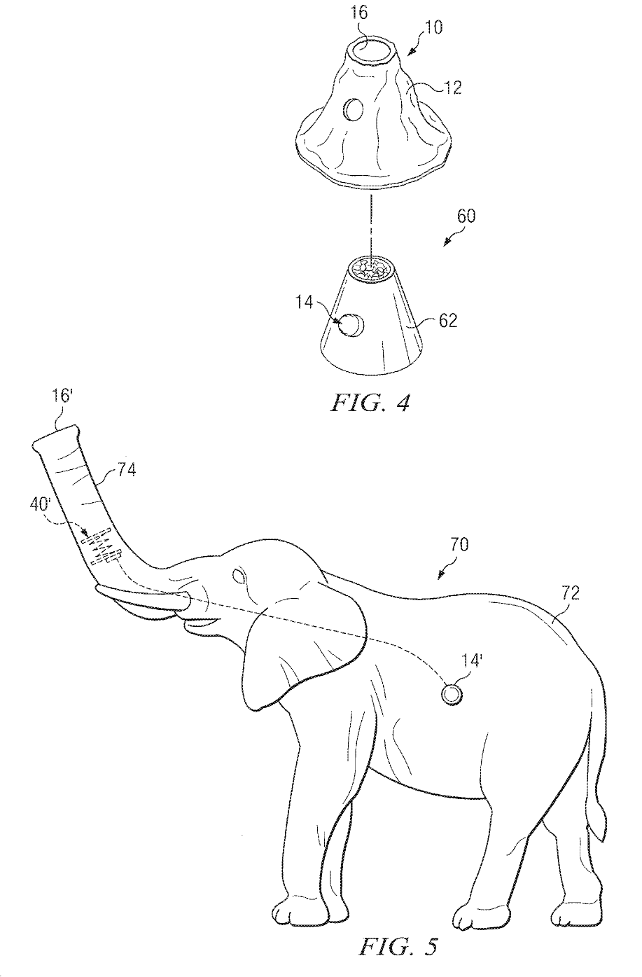

Referring now to FIG. 4 there is shown a piñata 60 comprising an alternative embodiment of the present invention. The piñata 60 differs from the piñata 10 of FIGS. 1 through 3B in that the piñata 60 further comprises an inner-structure 62 over which the base 12 is placed. The treats T and treat discharge apparatus 40 are therefore placed inside the inner-structure 62 rather than inside the base 12.

Referring now to FIG. 5 through 11, there are shown piñatas 70, 76, 82, 88, 94, 100, and 108, respectively, comprising alternate physical configurations of the piñata 10 shown in FIGS. 1 through 31. Many of the components of the piñatas 70, 76, 82, 88, 94, 100, and 108 are substantially identical in construction and function to the piñata 10 illustrated in FIGS. 1 through 3B and described hereinabove in conjunction therewith. Such identical component parts are designated in FIGS. 5 through 11 with the same reference numerals utilized above in the description of the piñata 10 but are differentiated therefrom by means of a prime (′) designation.

FIG. 5 illustrates piñata 70 comprising a base 72 in a shape resembling an elephant comprising a trunk 74 extending therefrom. The treat discharge apparatus 40′ and treats T may therefore be positioned within the trunk 74 with the treat discharge port 16′ on the distal end thereof.

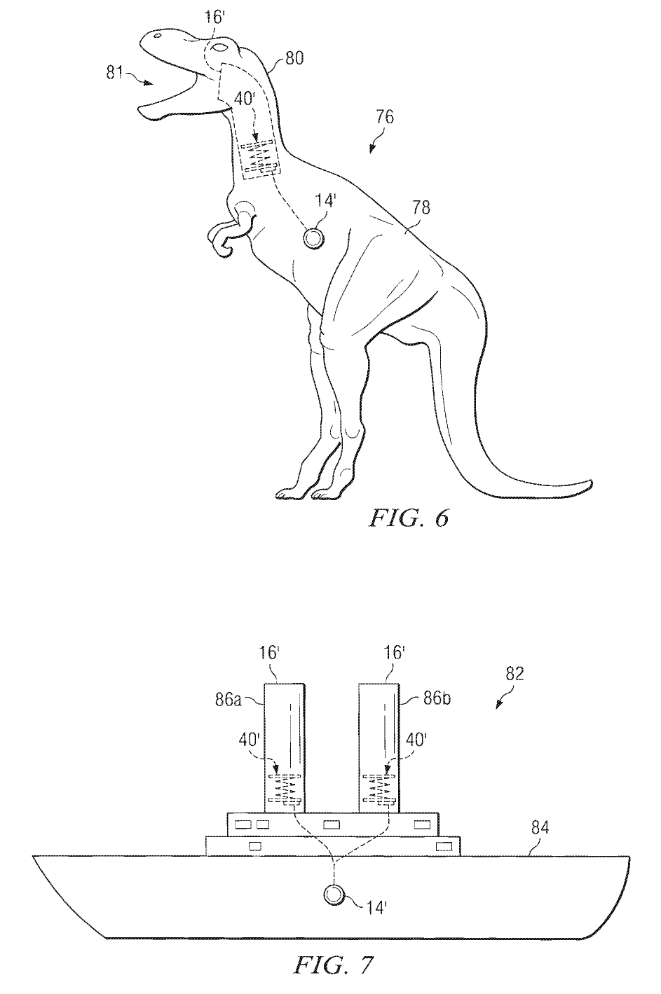

FIG. 6 illustrates a piñata 76 comprising a base 78 in a shape resembling a dinosaur having neck 80 and mouth 81. The treat discharge apparatus 40′ and treats T may therefore be positioned within the neck 80 with the treat discharge port 16′ positioned within the mouth 81.

FIG. 7 illustrates a piñata 82 comprising a base 84 in a shape resembling a boat having smokestacks 86a and 86b extending thereabove. The treat discharge apparatus 40′ and treats T may therefore be positioned within the smokestacks 86a and 86b with the treat discharge port 16′ on the distal ends thereof.

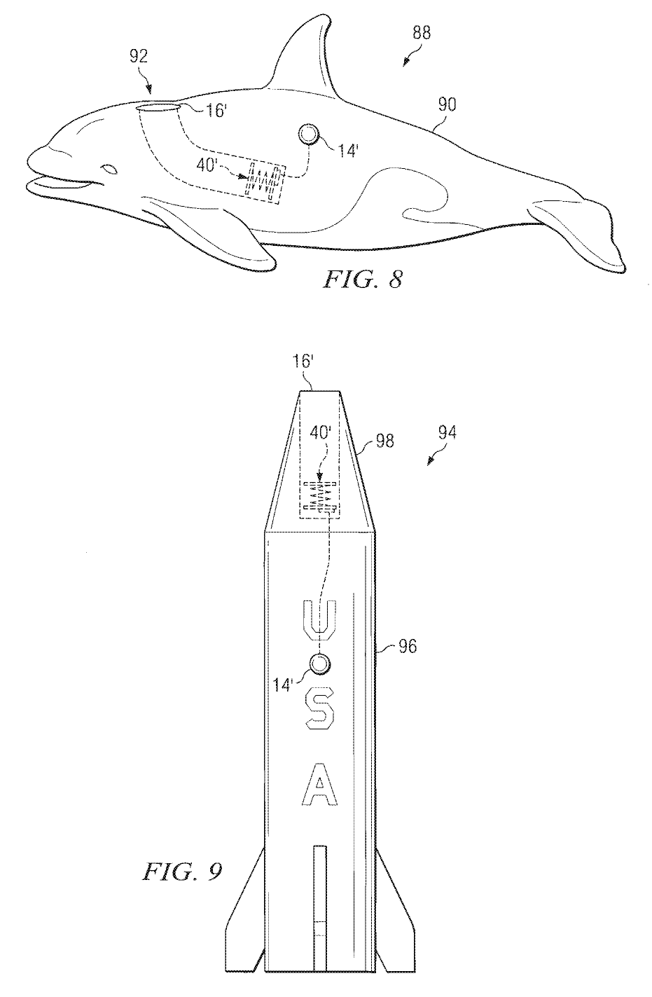

FIG. 8 illustrates a piñata 88 comprising a base 90 in a shape resembling a whale having a blowhole 92. The treat discharge apparatus 40′ and treats T may therefore be positioned within the base 90 with the treat discharge port 16′ at the top of the blowhole 92.

FIG. 9 illustrates a piñata 94 comprising a base 96 in a shape resembling a rocket having nose 98. The treat discharge apparatus 40′ and treats T may therefore be positioned within the base 96 with the treat discharge port 16′ at the top of the nose 98.

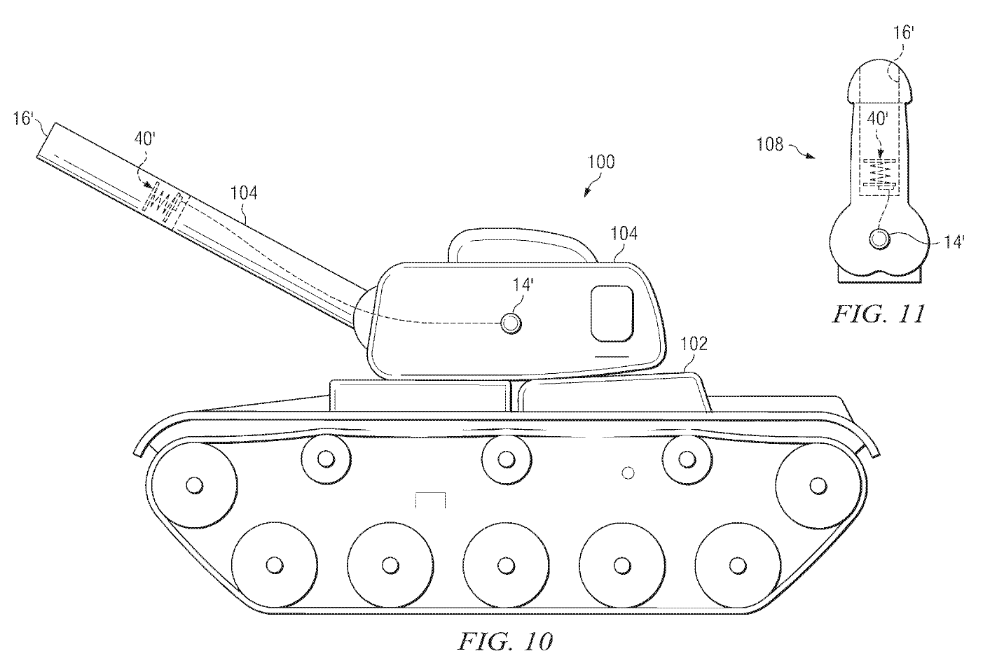

FIG. 10 illustrates a piñata 100 comprising a base 102 in a shape resembling a tank having a gun turret 104 on the top thereof, the gun turret having gun 106 extending thereof. The treat discharge apparatus 40′ and treats T may therefore be positioned within the turret 104 with the treat discharge port 161 at the top of the gun 106.

FIG. 11 illustrates a piñata 108 which may be configured as an adult toy comprising a target 14′, a discharge apparatus 40′, and a discharge port 16′.

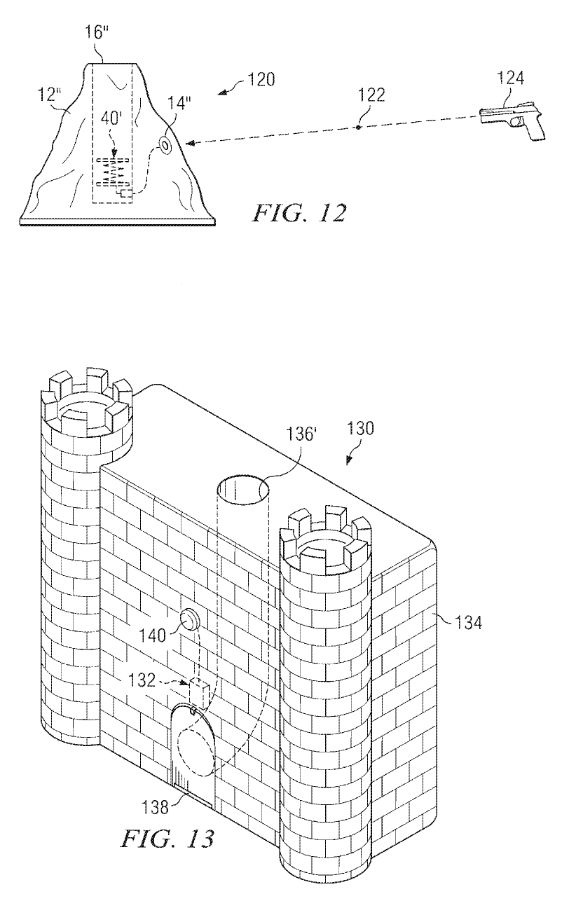

Referring now to FIG. 12, there is shown a piñata 120 comprising another embodiment of the present invention. Many of the components of the piñata 120 are substantially identical in construction and function to the piñata 10 illustrated in FIGS. 1 through 3B and described hereinabove in conjunction therewith. Such identical component parts are designated in FIG. 12 with the same reference numerals utilized above in the description of the piñata 10 but are differentiated therefrom by means of a double prime (″) designation. The piñata 120 differs from the piñata 10 in that the target 14″ may be relatively smaller in size and activated by a small projectile 122 discharged from gun 124.

Referring now to FIG. 13, there is shown a piñata 130 comprising yet another embodiment of the present invention. The piñata 130 is equipped with a treat discharge apparatus 132 that is not spring-loaded. The piñata 130 comprises a base 134 resembling the shape of a castle. The treat discharge apparatus 132 is mounted within the base adjacent to a treat holding compartment 136 therein and treat discharge door 138. A target 140 is mounted on the and supported by the base 132 of the piñata 130. The target 140 may be constructed, configured and operate similar to the target 14 shown in FIG. 2 and described hereinabove in conjunction therewith.

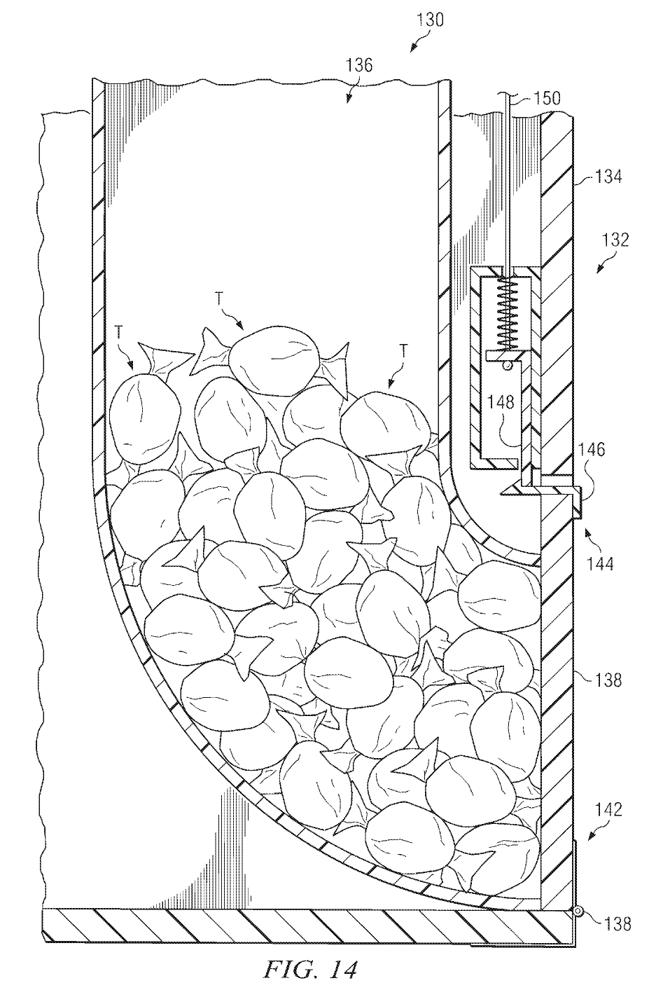

FIG. 14 comprises a sectional view of the treat discharge apparatus 132 and the treat holding compartment 136. As shown in FIG. 14 the treat discharge door 138 comprises a lower end 142 hingedly coupled with the base 134 and an upper end 144 comprising latch 146 thereon. A holding pin 148 coupled with a trip wire 150 engages the latch 146 maintaining the treat discharge door 138 in a closed position. When the target 140 is hit by a projectile such as described in conjunction with FIG. 1, the target 140 activates and moves the trip wire 150 upward thereby lifting the holding pin 148. The latch 146 thereupon disengages from the holding pin 148 enabling the treat discharge door 138 to fall open and discharge treats T.

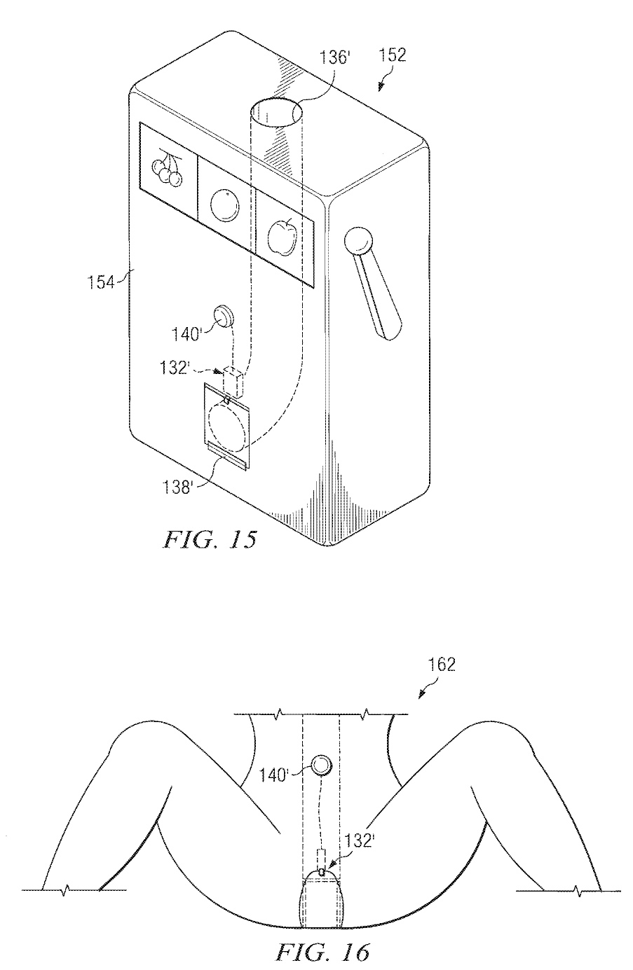

Referring now to FIGS. 15 and 16, there are shown piñatas 156 and 162, respectively, comprising alternate physical configurations of the piñata 130 shown in FIGS. 13 and 14. Many of the components of the piñatas 156 and 162 are substantially identical in construction and function to the piñata 130 illustrated in FIGS. 13 and 14 and described hereinabove in con-unction therewith. Such identical component parts are designated in FIGS. 13 and 14 with the same reference numerals utilized above in the description of the piñata 130 but are differentiated therefrom by means of a prime (′) designation.

FIG. 15 illustrates a piñata 156 comprising a base 158 in a shape resembling a gaming machine with a treat discharge door 138′ located where a winnings collection tray might traditionally be located on a gaming machine.

FIG. 16 illustrates a piñata 162 which may be configured as an adult toy and equipped with a target 140′ and a discharge apparatus 132′ of the type shown in FIG. 14 and described hereinabove in conjunction therewith.

Although preferred embodiments of the invention have been illustrated in the accompanying Drawings and described in the foregoing Detailed Description, it will be understood that the invention is no limited to the embodiments disclosed, but is capable of numerous rearrangements, modifications, and substitutions of parts and elements without departing from the spirit of the invention.

1. A reusable piñata comprising:
a non-frangible housing;
a treat discharge port formed in the housing;
a target mounted on the housing for engagement by a thrown object; and
means mounted within the housing and responsive to engagement of the target by a thrown object for discharging treats through the treat discharge port of the housing.

2. The reusable piñata according to claim wherein the means for discharging treats through the treat discharge port comprises a trip wire coupled with and extending from the target; an outer treat discharging piston and an interior piston received within the outer treat discharging piston; a spring mounted within the interior piston; a rod extending from the interior piston to a first latching member; a second latching member slidably supported within an inner housing, the housing supported within the non-frangible housing; wherein the trip wire is coupled with the inner housing, and wherein the second latching member is maintained in engagement with the first latching member by a compression spring about the trip wire positioned between the inner housing and the treat discharge port.

3. The piñata according to claim 1 wherein the means for discharging treats comprises a trip wire extending from the target and coupled with a holding pin; a treat discharge door hingedly secured to the non-frangible housing on a lower end thereof and comprising a latch on an upper end thereof, wherein the latch engages the holding pin thereby maintaining the treat discharge door in a closed position.

4. The piñata according to claim 1 wherein the target comprises a hemisphere supported on a rod which is slidably supported in a guide within the non-frangible housing.

5. The piñata according to claim 4 wherein the guide is formed integrally with the non-frangible housing.

6. The piñata according to claim 4 wherein the guide is secured to the non-frangible housing.

7. The piñata according to claim 1 comprising multiple treat discharge ports and means for discharging the treats therefrom.

8. A reusable piñata comprising:
a non-frangible housing;
a treat holding compartment formed in the housing;
a treat discharge door comprising an upper and lower end hingedly coupled with the non-frangible housing at the lower end thereof;
a target mounted on the housing for engagement by a thrown object; and
means mounted within the housing and responsive to engagement of the target by a thrown object for discharging treats through the treat discharge port of the housing.

9. The piñata according to claim 8 wherein the means for discharging treats a trip wire extending from the target and coupled with a holding pin and a latch comprising the upper end of the treat discharge door wherein the latch engages the holding pin thereby maintaining the treat discharge door in a closed position.

10. The piñata according to claim 8 wherein the target comprises a hemisphere supported on a rod which is slidably supported in a guide within the non-frangible housing.

11. The piñata according to claim 10 wherein the guide is formed integrally with the non-frangible housing.

12. The piñata according to claim 10 wherein the guide is secured to the non-frangible housing.

13. The piñata according to claim 8 comprising multiple treat discharge doors, multiple treat holding compartments; and means for discharging the treats from the treat holding compartments through the discharge doors.

14. A reusable piñata comprising:
an inner base;
a decorative outer non-frangible housing supported on the inner base;
a treat discharge port;
a target mounted on the inner base and extending through the outer non-frangible housing for engagement by a thrown object; and
means mounted within the inner base and responsive to engagement of the target by a thrown object for discharging treats through the treat discharge port.

15. The reusable piñata according to claim 14 wherein the means for discharging treats through the treat discharge port comprises a trip wire coupled with and extending from the target; an outer treat discharging piston and an interior piston received within the outer treat discharging piston; a spring mounted within the interior piston; a rod extending from the interior piston to a first latching member; a second latching member slidably supported within an inner housing, the housing supported within the inner base; wherein the trip wire is coupled with the inner housing, and wherein the second latching member is maintained in engagement with the first latching member by a compression spring about the trip wire positioned between the inner housing and the treat discharge port.

16. The piñata according to claim 14 wherein the target comprises a hemisphere supported on a rod which is slidably supported in a guide within the inner base.

17. The piñata according to claim 14 wherein the guide is formed integrally with the inner base.

18. The piñata according to claim 14 wherein the guide is secured to the non-frangible housing.
